(19) United States
(12) Patent Application Publication
(10) Pub. No.: US 2008/0096537 A1
(43) Pub. Date: Apr. 24, 2008

(54) Operating A Mobile Device

(76) Inventors: Zeljko Milojkovic, Oulu (FI); Teemu Latti, Oulu (FI)

Correspondence Address: HOFFMANN & BARON, LLP, 6900 JERICHO TURNPIKE, SYOSSET, NY, 11791, US

(21) Appl. No.: 11/661,207

(22) PCT Filed: Jun. 3, 2005
(86) PCT No.: PCT/FI05/50195

§ 371 Date: Feb. 26, 2007

(51) Int. Cl. H04M 3/00; H04Q 7/20; H04Q 7/32

(52) U.S. Cl. 455/418; 455/466; 455/414.1

(57) ABSTRACT

The invention relates to a system and associated software for operating a mobile device. The system comprises an external control system and a mobile device being controlled by the external control system. The external control system provides the mobile device with functional modules which comprise software and which are installed and executed remotely from the external control system without any user action at the mobile device end.

### CROSS-REFERENCE TO RELATED APPLICATION

This application is a National Phase application of International Application No. PCT/FI2005/050195 filed Jun. 3, 2005, which is incorporated herein by reference.

### BACKGROUND OF THE INVENTION

1. Field of the Invention

The invention relates to a method of operating a mobile device of a wireless telecommunications system, a mobile device of a wireless telecommunications system, and computer programs related to operation of a mobile device of a wireless telecommunications system.

2. Description of the Related Art

Increased processing power and other capabilities of mobile devices of wireless telecommunications systems enable a great variety of computer processes to be executed in mobile devices.

Typically, installation of software and execution of the associated computer process involves cumbersome user actions, where a plurality of commands is required to be inputted to a mobile device by means of a user interface of the mobile device. Such situations occur, for example, during the manufacture, testing and maintenance of the mobile device. Therefore, it is useful to consider improvements for operating a mobile device of a wireless telecommunications system.

### SUMMARY OF THE INVENTION

An object of the invention is to provide an improved method, mobile device and computer programs. According to a first aspect of the invention, there is provided a method of operating a mobile device of a wireless telecommunications system, the method comprising: providing the mobile device with at least one functional module from an external control system, the functional module comprising coded instructions for executing a module process in the mobile device; generating, in the external control system, an installation message comprising instructions for installing the at least one functional module into the mobile device; communicating the installation message to a local server located in the mobile device; installing the at least one functional module into the mobile device as a response to the installation message; generating, in the external control system, an execution message comprising coded instructions for executing at least a part of the module process in the mobile device; communicating the execution message to the local server; routing the execution message by the local server to the at least one functional module; and executing the at least a part of the module process as a response to the execution message.

According to a second aspect of the invention, there is provided a mobile device of a wireless telecommunications system, the mobile device comprising: a communication module for communicating functional modules provided by an external control system to the mobile device, a functional module comprising coded instructions for executing a module process in the mobile device; and a local server connected to the communication module, the local server for installing at least one functional module communicated over the communication module to the mobile device as a response to an installation message generated by the external control system and communicated over the communication module, the local server being configured to route an execution message generated by the external control system to the at least one functional module, the execution message comprising instructions for executing at least a part of the module process.

According to a third aspect of the invention, there is provided a computer program embodied on a distribution medium readable by a computer and encoding a computer program of instructions for executing a computer process for operating a mobile device of a wireless telecommunications system, computer process comprising: providing the mobile device with at least one functional module from an external control system, the functional module comprising coded instructions for executing a module process in the mobile device; generating, in the external control system, an installation message comprising instructions for installing the at least one functional module into the mobile device; communicating the installation message to a local server located in the mobile device; installing the at least one functional module into the mobile device as a response to the installation message; generating, in the external control system, an execution message comprising coded instructions for executing at least a part of the module process in the mobile device; communicating the execution message to the local server; routing the execution message by the local server to the at least one functional module; and executing the at least a part of the module process as a response to the execution message.

According to a fourth aspect of the invention, there is provided a computer program embodied on a distribution medium readable by a computer and encoding a computer program of instructions for executing a computer process in a mobile device of a wireless telecommunications system, the computer process comprising: communicating at least one functional module from an external control system to the mobile device, the functional module comprising coded instructions for executing a module process in the mobile device; communicating an installation message generated by the external control system; installing at least one functional module into the mobile device as a response to the installation message; routing an execution message generated by the external control system to the at least one functional module; and executing at least a part of the module process as a response to the execution message.

According to another second aspect of the invention, there is provided a computer program embodied on a distribution medium readable by a computer and encoding a computer program of instructions for executing a computer process in an external control system, the computer process comprising: providing the mobile device with at least one functional module, the functional module comprising coded instructions for executing a module process in; generating an installation message comprising instructions for installing the at least one functional module into the mobile device; communicating the installation message to the mobile device; generating an execution message comprising coded instructions for executing at least a part of the module process in the mobile device; and communicating the execution message to the mobile device.

The invention provides several advantages. The invention enables the user to install and execute computer programs of a mobile device by solely using user interface located in a control system external from the mobile device.

### BRIEF DESCRIPTION OF THE DRAWINGS

In the following, the invention will be described in greater detail with reference to embodiments and the accompanying drawings, in which

FIG. 1 shows a first example of a structure of a system for operating a mobile device;

FIG. 2 illustrates a second example of a structure of a system for operating a mobile device;

FIG. 3 shows an example of an interface between a local server and a functional module;

FIG. 4 shows a first flow chart illustrating a methodology according to embodiments of the invention;

FIG. 5 shows a second flow chart illustrating a methodology according to embodiments of the invention;

FIG. 6 shows a third flow chart illustrating a methodology according to embodiments of the invention;

FIG. 7 shows a fourth flow chart illustrating a methodology according to embodiments of the invention;

FIG. 8 shows a fifth flow chart illustrating a methodology according to embodiments of the invention; and

FIG. 9 shows a sixth flow chart illustrating a methodology according to embodiments of the invention.

### DETAILED DESCRIPTION OF THE PREFERRED EMBODIMENTS

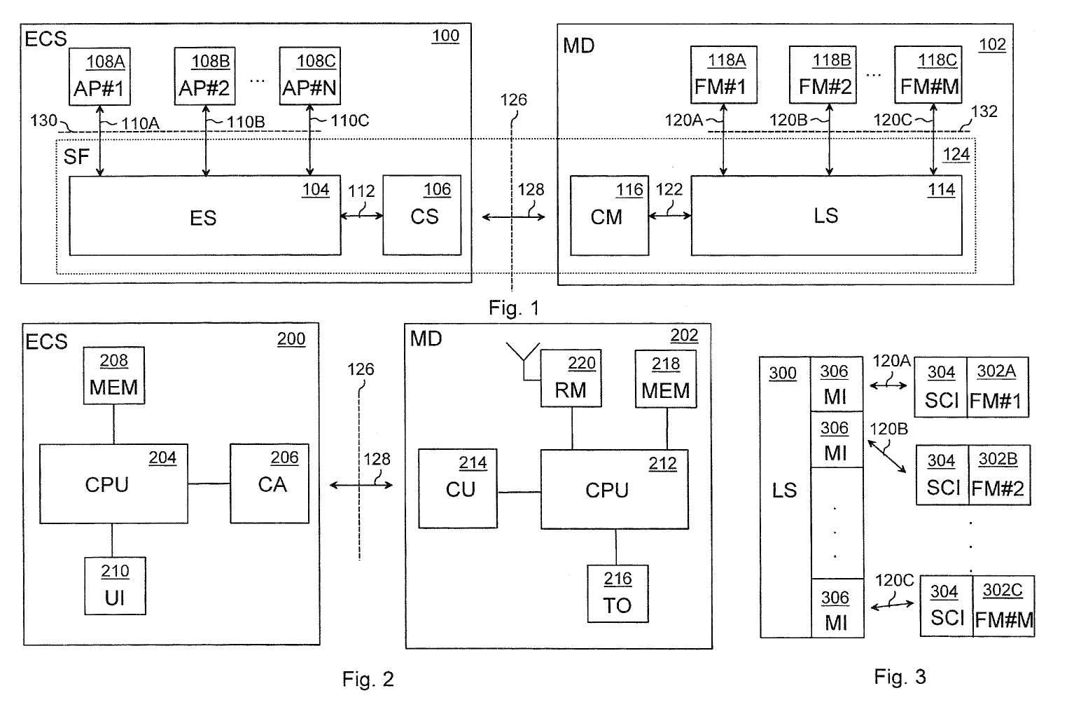

With reference to FIG. 1, examine an example of a system for operating a mobile device, where the system comprises an external control system (ECS) 100 and a mobile device (MD) 102 being operated.

The external control system 100 and the mobile device 102 typically comprise a communication system (CS) 106 and a communication module (CM) 116, respectively, for implementing a communication interface (CI) 126 between the external control system 100 and the mobile device 102. The communication interface 126 enables data streams 128 to be transferred between the external control system 100 and the mobile device 102.

The external control system 100 may be connected to and control a plurality of mobile devices simultaneously.

The mobile device 102 is typically a handheld wireless communication device with a capability of connecting to a wireless telecommunications system over an air interface. The mobile device 102 may also be referred to as a mobile phone, user equipment, mobile terminal and/or mobile station.

The wireless telecommunications system may be implemented with at least one of the following radio access technologies: GSM (Global System for Mobile Communications), GERAN (GSM/EDGE Radio access network), GPRS (General Packet Radio Service), E-GPRS (EDGE GPRS), UMTS (Universal Mobile TelecommunicationsiSystem), CDMA2000 (CDMA, Code Division Multiple Access), US-TDMA (US Time Division Multiple Access), TDS-CDMA (Time Division Synchronization CDMA) and/or WLAN (Wireless Local Access Network).

The mobile device 102 typically utilizes an operating system supporting APIs and enabling access to at least a part of the file system of the mobile device 102 from the external control system 100. Furthermore, the operating system may support technology of executable code loading at run time, such as dynamically loaded DLLs (Dynamic Link Libraries), which can be loaded into memory once and called by one or more applications at run time so that the operating system dynamically resolves entry points or addresses of called routines. Such operating systems include, for example, different generations of a Symbian operating system, such as Symbian versions 6.0, 7.0 and 8.0, and more advanced Symbian versions and derivatives thereof.

The communication interface 126 may be based, for example, on a short-range wireless technology, such as Bluetooth and/or infrared technology.

In an embodiment of the invention, the communication interface 126 is implemented with the radio access technology applied by the wireless telecommunications system.

In an embodiment of the invention, the communication interface 126 is based on a cable connection using a USB (Universal Serial Bus) and/or RS-232, for example.

The given list of communication technologies applied by the communication interface 126 is not, however, exclusive but the communication interface 126 may be implemented with any communication technology applying either wireless and/or wired data transfer.

Furthermore, the communication system 106 and the communication module 116 may implement a communication protocol, such as a TCP/IP (Transport Control Protocol/Internet Protocol) for transferring the data streams 128 between the external control system 100 and the mobile device 102.

The external control system 100 comprises an external server (ES) 104 connected to the communication system 106, and at least one application (AP#1, AP#2, . . . , AP#N) 108A, 108B, 108C logically connected to the external server 104.

The external control system 100 may be based on a personal computer, a laptop, a PDA (Personal Digital Assistant), another mobile device or data system with a user interface and a capability of connecting to the mobile device 102 and a capability of executing applications 108A to 108C and tasks of the external server 104.

The communication system 106 may comprise parts of the wireless telecommunications system. In such a case, the external server 104 may be connected to the communication system 106 over the air interface of the wireless telecommunications system and/or over the Internet.

Parts of the external control system 100 may utilize a standardized operating system, such as Windows and/or Linux. The standardized operating system may provide application APIs 130 between the applications 108A to 108C and the external server 104. An application API is typically a set of commands which applications can call on the operating system or some part of it, or on another application.

The mobile device 102 comprises a local server 114 connected to the communication module 116, and at least one functional module 118A, 118B, 118C logically connected to the local server 114.

The external server 104 and the local server 114 form a core of a server framework 124, which acts as an interface between the applications 108A to 108C and the functional modules 118A to 118C.

The functional module 118A to 118C is a software component comprising coded instructions for executing a module process in the mobile device 102 as a response to an execution message received from the application 108A to 108C via the server framework 124. For the ease of discussion and without any ambiguity, the functional module 118A to 118C may also be referred to as a computer process executed in the mobile device 102.

The module process is a computer process executed on the basis of coded instructions included by a functional module 118A to 118C. The module process may be any computer process resulting in a desired functionality in the mobile device 102.

In an embodiment of the invention, the module process of at least one functional module 118A to 118C is a test process for testing at least one test object of the mobile device 102. The test object may be a software component, such a user application, and/or a hardware component, such as the user interface and/or a radio frequency component.

The test process may be executed at a production line during the manufacture of the mobile device 102. In an application, the test process may be executed during a customer service. The test environment is not, however, restricted to the presented one, but may be any environment or situation where a test of the mobile device 102 is required.

The applications 108A to 108C are typically connected to the external server 104 over application APIs 130 which allow applications 108A to 108C to exchange application data stream 110A, 110B, 110C with the external server 104.

The functional modules 118A to 118C are typically connected to the local server 114 over module APIs 132 provided by the local server 114. The module APIs allow functional modules 108A to 108C to exchange a module data stream 120A, 120B, 120C with the local server 114.

The contents of the application data stream 110A to 110C typically depend on whether the application data stream 110A to 110C is an input data stream or an output data stream from the viewpoint of the application 108A to 108C.

When the application data stream 110A to 110C is an output data stream, the application data stream 110A to 110C may contain the functional modules 118A to 118C and/or control messages. The control messages may include an installation message and/or an execution message. The installation message includes instructions for the local server 114 for installing a functional module 118A to 118C into the mobile device 102. The execution message includes instructions for a functional module 118A to 118C for executing at least a part of a module process of a functional module 118A to 118C. Execution of at least a part of the module process comprises loading the at least part of the module into a working memory from a permanent memory and running the process in the processor of the mobile device 102.

The installation message enables the user to install the functional module 118A to 118C into the mobile device 102 by using solely the application 108A to 108C without any user actions at the mobile device 102.

In an embodiment of the invention, the operating system of the mobile device 102 is not modified as a result of the installation.

The execution message enables the user to execute the module process of the functional module 118A to 118C by using solely the application 108A to 108C without any user actions at the mobile device 102.

When the application data stream 110A to 110C is an output data stream, the application data stream may further include an application identity, a module identity, a request identity and/or control parameters.

The application identity is an application-specific identity associated with an application 108A to 108C. A functional module 118A to 118C may identify a source of the application data stream 110A to 110C on the basis of the application identity. The application identity may be used to address and route messages incorporated into the application data stream 110A to 110C to a desired application 108A to 108C.

The module identity is a functional-module-specific identity associated with a functional module 118A to 118C. The module identity may be used for addressing and routing control messages incorporated into the application data stream 110A to 110C to a desired functional module 118A to 118C.

The request identity specifies a module process being executed in a functional module 118A to 118C. The request identity is typically an ordinal number of the command to be executed on the basis of the execution message. The request identity may also identify an answer to an execution command, or an error. The request identity may also identify only a part of the execution command, as some execution commands may require many messages in order to get all the parameters.

The control parameters may include parameters which control the module process of the functional module 118A to 118C. The control parameters may specify how the computer process defined by the request identity is executed.

When the application data stream 110A to 110C is an input data stream, the application data stream 110A 110C may include response messages generated in a functional module 118A to 118C as a response to the execution message. In such a case, the application data stream 110A to 110C may contain an application identity, a module identity, a response identity, and/or module output parameters.

The application identity may be used for routing messages generated in the functional module 118A to 118C and incorporated into the application data stream 110A to 110C to a desired application 108A to 108C. The application 108A to 108C may identify the functional module 118A to 118C from which the application data stream 110A to 110C originates by means of the module identity. With the response identity, the application 108A to 108C may identify a response of the functional module 118A to 118C.

The module data stream 120A to 120C is a data stream for communication between the functional module 118A to 118C and the local server 114.

The contents of the module data stream 120A to 120C depend on whether the module data stream 120A to 120C is an input module data stream or an output module data stream.

When the module data stream 120A to 120C is an input data stream, the module data stream 120A to 120C may include the application identity associated with the application 108A to 108C from which the control message originates, the request identity, and control parameters for controlling the module process of the functional module 118A to 118C. The control message may be an execution message.

When the module data stream 120A to 120C is an output data stream, the module data stream 120A to 120C may include a response message including response parameters characterizing a response of the functional module 118A to 118C to the execution message. The application 108A to 108C typically provides a user of the system with a user interface, which enables the user to control the functional modules 118A to 118C by using the external control system 100.

The application 108A to 108C typically provides the mobile device 102 with at least one functional module 118A to 118C over the server framework 124.

The local server 114 may have a register of installed and/or up-to-date functional modules 118A to 118C and it may inform the external server 104 about a current state of the functional modules 118A to 118C. If a functional module 118A to 118C requires an installation and/or an update, the application 108A to 108C may fetch a desired functional module 118A to 118C from a memory of the external control system 100, incorporate the functional module 118A to 118C into the application data stream 110A to 110C and input the application data stream 110A to 110C into the external server 104. The external server 104 receives the application data stream 110A to 110C and delivers the functional module 118A to 118C to the communication system 106 in a communication signal 112.

The operating system of the mobile device 102 may require a user acknowledgement for installing software into the operating system of the mobile device 102. The user acknowledgement is typically provided by pressing a key in the user interface of the mobile device 102, and thereby required direct access to the mobile device 102. Therefore, it may be required that such a requirement for the user acknowledgement be overridden in order to install the functional module 118A to 118C with the installation message and without directly accessing the mobile device 102.

The communication system 106 receives the communication signal 112 and transmits the functional module 118A to 118C into the mobile device 102 in the data stream 128 over the communication interface 126.

The communication module 116 receives the data stream 128 and inputs a data stream 122 including the functional module 118A to 118C into the local server 114.

The application 108A to 108C may further generate an installation message which comprises instructions for installing the functional module 118A to 118C into the operating system of the mobile device. The installation message is incorporated into the application data stream 110A to 111C outputted by the application 108A to 108C. The external server 104 receives the installation message and communicates the installation message to the local server 114 over the communication interface 126 by means of the communication system 106 and the communication module 116.

The local server 114 installs the functional module 118A to 118C to the mobile device 102 as a response to the installation message generated by the external control system 100.

After the installation of the functional module 118A to 118C, the local server 114 may update its registers on installed functional modules 118A to 118C.

An execution message is typically generated in the application 108A to 108C as a result of a user action or an automated event. The execution message is incorporated into the application data stream 110A to 110C and inputted into the external server 104.

The external server 104 receives the execution message and communicates the execution message to the local server 114 over the communication interface 126 by means of the communication system 106 and the communication module 116.

The local server 114 receives the execution message and incorporates the execution message into the module data stream 120A to 120C and routes the execution message to a target functional module 118A 118C. The routing may be based on the module identity incorporated into the application data stream 110A to 110C.

The functional module 118A to 118C receives the execution message and executes the module process according to the request identity incorporated into the execution message.

In an embodiment of the invention, the external server 104 provides the local server 114 with local server software and communicates the local server software into the mobile device 102. The mobile device 102 receives the local server software and installs the local server software into the mobile device 102. As a result, the local server 114 is obtained.

In an embodiment of the invention, the functional module 118A to 118C generates a response message as a response to the execution message and outputs the response message into the local server 114. The local server 114 routes the response message to the external control system 100 over the communication interface 126. The external control system 100 receives the response message and routes the response message to the application 108A to 108C identified in the response message. The response message is received in the application 108A to 108C and processed. A process may include converting the response message into a form which may be shown to the user. The process may also include combining information from different response messages.

The response message may include error codes which indicate either success of failure of a test performed by the functional module 118A to 118C.

In an embodiment of the invention, a remove message is generated in an application 108A to 108C. The remove message is communicated to the local server 114 over the communication interface 126. The local server 114 removes the functional module 118A to 118C indicated in the remove message from a permanent memory of the mobile device 102 as a response to the remove message.

The response message and remove message may be incorporated into the application data stream 110A to 110C and the module data stream 120A to 120C.

With reference to FIG. 2, the external control system 200 may comprise a communication adapter 206, a central processing unit (CPU) 204 connected to the communication adapter 206, a memory unit 208 connected to the central processing unit 204, and a user interface (UI) 210.

The communication adapter 206 implements the communication system 106. The communication adapter 206 may be a Bluetooth adapter, an infrared adapter, such as an IrDA adapter (Infrared Data Association), and/or an RS-232 adapter. The communication adapter 206 is not, however, restricted to the given examples.

The memory unit 208 may comprise a hard drive, a RAM (Random Access Memory), a ROM (Read-only Memory) and/or a CD (Compact Disc).

The memory unit 208 may include the software of the applications 108A to 108C, software of the external server 104 and software of the communication system 106.

The user interface 210 may comprise a keyboard, a display, a pointing device, such as a mouse. The user interface 210 is not restricted to the listed elements but may comprise any means via which a user is capable of communicating with the software executed in the central processing unit 204.

The mobile device 202 comprises a communication unit (CU) 214, a central processing unit (CPU) 212, a radio modem (RM) 220 connected to the central processing unit 212, a memory unit (MEM) 218 connected to the central processing unit 212, and a test object 216 (TO).

The communication unit 214 implements the communication module 116 of FIG. 1. The communication unit 214 may be a Bluetooth device, an infrared device, such as an IrDA device (Infrared Data Association), and/or an RS-232 device. The communication unit 214 is not, however, restricted to the given examples.

The radio modem 220 implements a wireless telecommunications system radio interface. A structure of the radio modem 220 is known to a person skilled in the art.

The test object 216 may be a hardware component and/or a software component applied to the mobile device 102. The hardware component comprises a display, a keypad, an audio device, a radio frequency component, and an amplifier without restricting the hardware component to the listed components. The software component comprises user applications executed in the mobile device 102, and embedded software.

With reference to FIG. 3, consider an interface between a local server 300 and a functional module 302A, 302B, 302C. In an embodiment of the invention, the functional module 302A to 302C comprises a common communication interface (SCI) 304 for communicating with the local server 300. The local server 300 comprises a plurality of identical module interfaces 306 compatible with the common communication interface 304. A compatibility may be associated with, for example, the use of handle commands and retrieve results command. As a result of the common communication interface 304 and an identical module interface 306, any functional module 302A to 3042C is capable of communicating with any module interface 306.

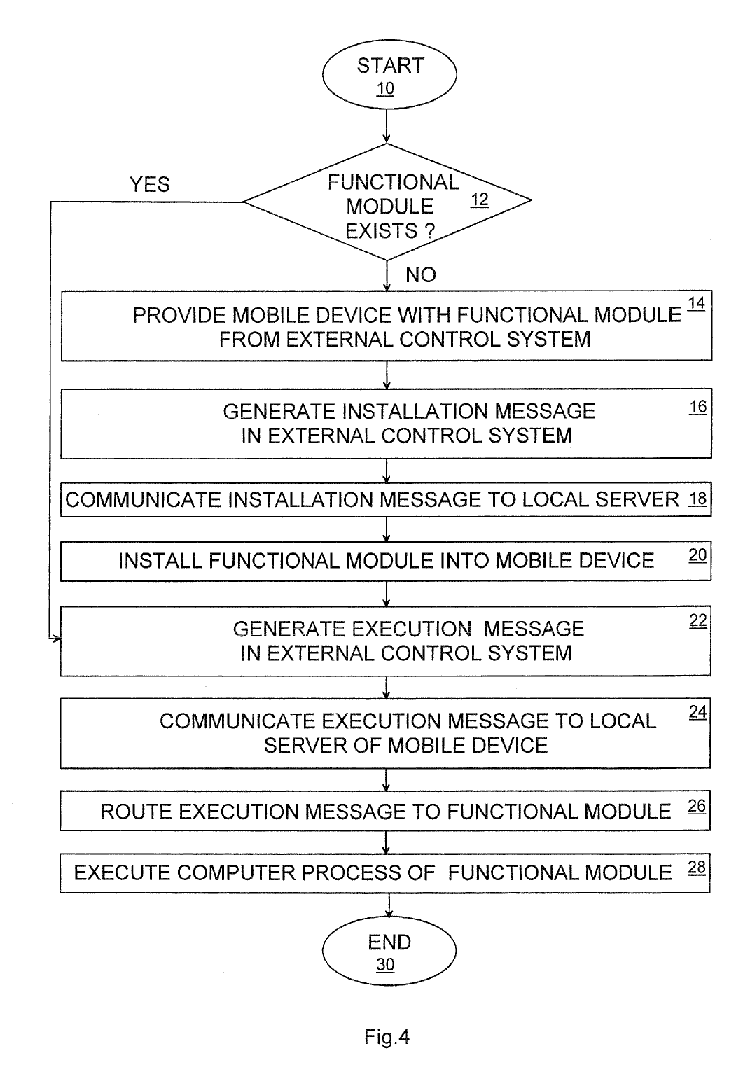

With reference to FIGS. 4, 5, 6, 7, 8 and 9, methodologies according to embodiments of the invention are shown with flow chart presentations.

In 10 in FIG. 4, the method starts.

In 12, it is checked whether or not the at least one functional module 118A to 118C exists in the mobile device 102. If the at least one functional module 118A to 118C exists in the mobile device 102, an execution message may be generated in 22. If not, the at least one functional module 118A to 118C is provided in 14.

In 14, the mobile device 102 is provided with at least one functional module 118A to 118C from an external control system for, the functional module 118A to 118C comprising coded instructions for executing a module process in the mobile device 102.

In 16, an installation message comprising instructions for installing the at least one functional module 118A to 118C into the mobile device 102 is generated in the external control system 100.

In 18, the installation message is communicated to a local server located in the mobile device 102.

In 20, the at least one functional module 118A to 118C is installed into the mobile device 102 as a response to the installation message.

In 22, an execution message comprising coded instructions for executing at least a part of the module process in the mobile device 102 is generated in the external control system.

In 24, the execution message is communicated to the local server 114.

In 26, the execution message is routed to the at least one functional module 118A to 118C by the local server 114.

In 28, the at least a part of the module process is executed as a response to the execution message.

In 30, the method ends.

In an embodiment of the invention, step 12 is carried out after step 22. In such a case, the execution message may result in a successful execution of the module process if the functional module 118A to 118C has already been installed into the mobile device 102. If the execution message results in a failed execution of the module process, the local server 114 may inform the external server about a failure. In such a case, the external server 104 may initiate a process, i.e. steps 14, 16, 18, for installing the missing functional module 118A to 118C into the mobile device 102.

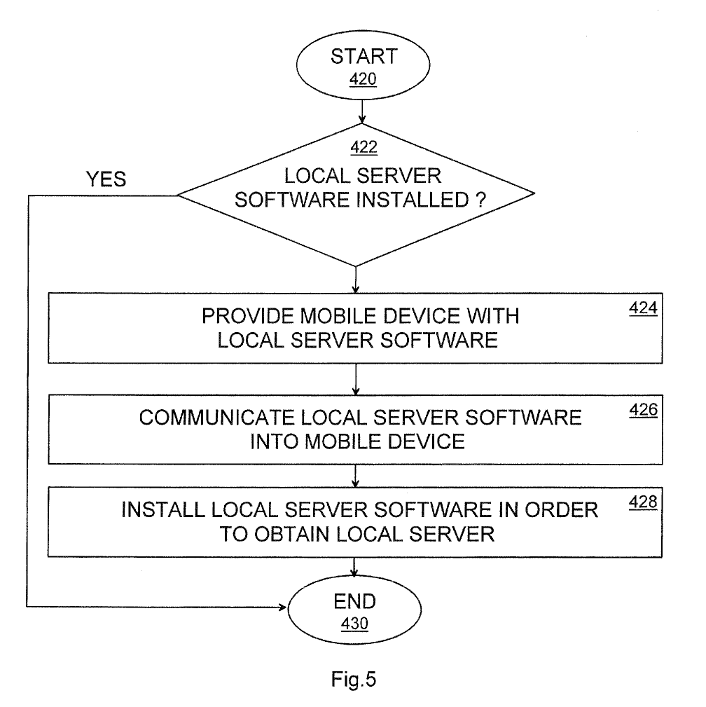

With reference to FIG. 5, the method starts in 420. The method steps of FIG. 5 may be executed prior to those shown in FIG. 4.

In 422, it is inquired whether or not a local server 114 exists, i.e. whether or not the local server software has been installed.

If the local server software has been installed, the method ends in 434.

If the local server software has not been installed, the mobile device 102 is provided with the local server software in 424.

In 426, the local server software is communicated into the mobile device 102.

In 428, the local server software is installed into the mobile device in order to obtain the local server 104.

In 430, the method ends.

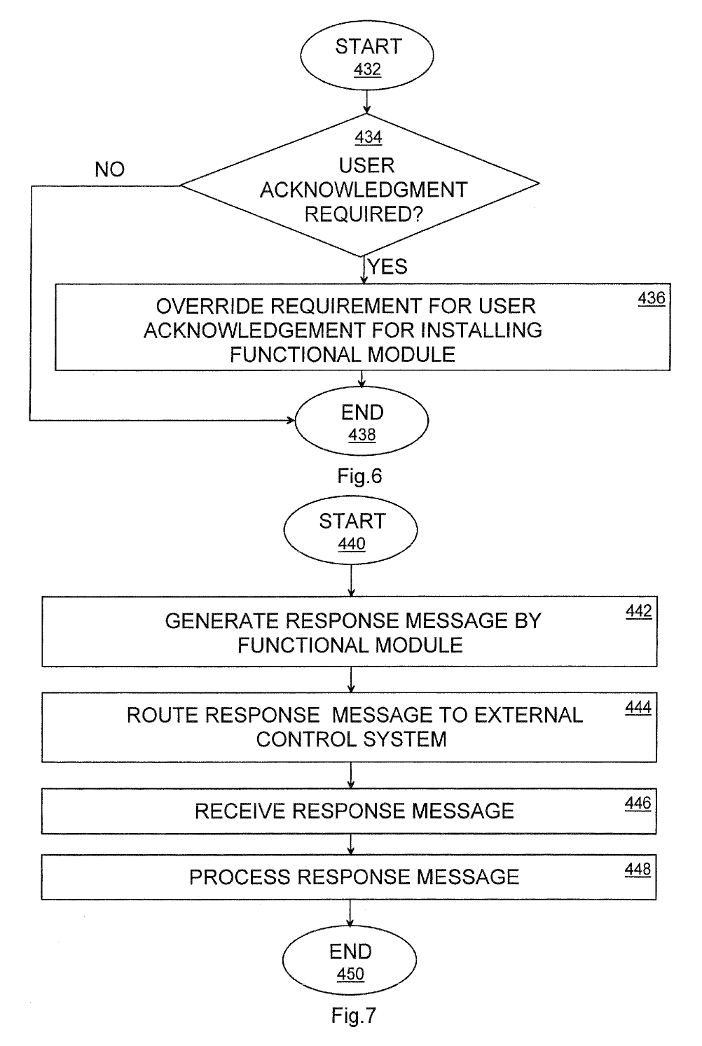

With reference to FIG. 6, the method starts in 432. The method steps of FIG. 6 may be executed prior method step 20 of FIG. 4.

In 434, it is inquired whether the operating system of the mobile device requires a user acknowledgement for installing the at least one functional module 118A to 118C as a response to the installation message.

If such a requirement exists, the requirement for user acknowledgement is overridden in 436.

In 438, the method ends.

With reference to FIG. 7, the method starts in 440. The method steps of FIG. 7 may be executed after method step 28 of FIG. 4.

In 442, a response message is generated by the functional module 118A to 118C as a response to the execution message.

In 444, the response message is routed to the external control system 100 by the local server 114.

In 446, the response message is received.

In 448, the response message is processed.

In 450, the method ends.

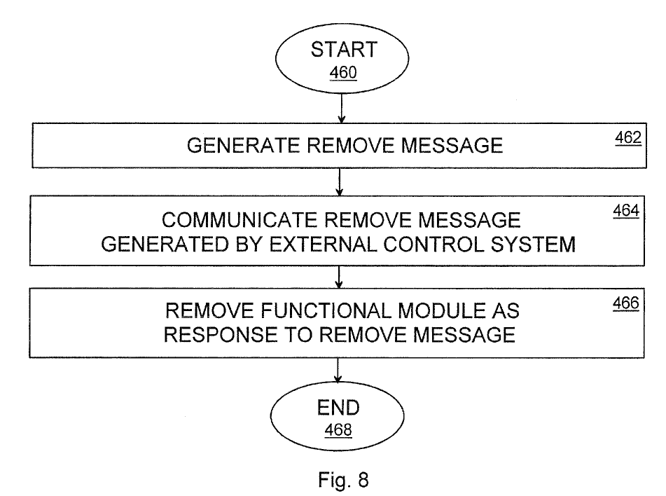

With reference to FIG. 8, the method starts in 460. The method steps of FIG. 8 may be executed after step 28 of FIG. 4.

In 462, a remove message comprising instructions for removing at least one functional module 118A to 118C from the mobile device 102 is generated in the external control system 102.

In 464, the remove message generated by the external control system 102 is communicated to the local server 114.

In 466, the at least one functional module 118A to 118C is removed by the local server 114 as a response to the remove message.

In 468, the method ends.

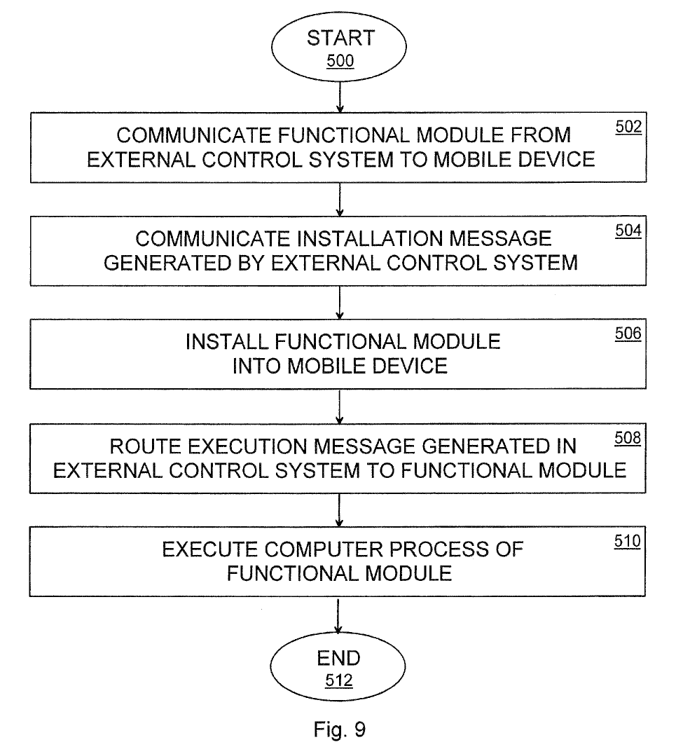

With reference to FIG. 9, the method starts in 500. The method steps of FIG. 9 are executed in the mobile device 102.

In 502, at least one functional module 118A to 118C is communicated from an external control system 100 to the mobile device 102.

In 504, an installation message generated by the external control system 100 is communicated.

In 506, at least one functional module 118A to 118C is installed into the mobile device 102 as a response to the installation message.

In 508, an execution message generated by the external control system 100 is routed to the at least one functional module 118A to 118C.

In 510, at least a part of the module process is executed as a response to the execution message.

In 512, the method ends.

In an aspect, the invention provides a computer program embodied on a distribution medium readable by a computer and encoding a computer program of instructions for executing a computer process for operating a mobile device of a wireless telecommunications system. The computer process is described with flow charts of FIGS. 1 to 9 and the associated description. An implementation is described in conjunction with FIGS. 1, 2 and 3. Parts of the computer program may be distributed between the external control system and the mobile device. Parts of the computer program may be stored in the memory unit 208 and executed in the central processing unit 204 of the external control system 200. Parts of the computer program may be stored in the memory unit 218 and executed in the central processing unit 212 of the mobile device 102.

In an aspect, the invention provides a computer program embodied on a distribution medium readable by a computer and encoding a computer program of instructions for executing a computer process in the mobile device 102 of a wireless telecommunications system. The computer process in the mobile device 102 is described with the flow chart of FIG. 9 and the associated description. Some embodiments of the computer process are described in FIGS. 1 to 8 and the associated description. An implementation is described in conjunction with FIGS. 1, 2 and 3. The computer program may be stored in the memory unit 218 and executed in the central processing unit 212 of the mobile device 102.

In an aspect, the invention provides a computer program embodied on a distribution medium readable by a computer and encoding a computer program of instructions for executing a computer process in an external control system 100. The computer process in the external control system 100 is described with the flow charts of FIG. 1 to 9 and the associated description. An implementation is described in conjunction with FIGS. 1, 2 and 3. The computer program may be stored in the memory unit 208 and executed in the central processing unit 204 of the external control system 200.

The computer program in the aforementioned aspects may be stored on a computer program distribution medium readable by a computer or a processor. The computer program medium may be, by way of example but not limited thereto, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

The invention enables the user of the system comprising the external test server 100 and the mobile device 102 to install and execute functional modules 118A to 118C remotely from the external test system 100 without inputting commands into the mobile device 102 via a user interface of the mobile device 102. The external test system 100 may provide advanced user interface capabilities and processing power for analyzing processes executed in the mobile device 102.

Even though the invention has been described above with reference to an example according to the accompanying drawings, it is clear that the invention is not restricted thereto but it can be modified in several ways within the scope of the appended claims.

1. A method of operating a mobile device of a wireless telecommunications system, the method characterized by
providing (14) the mobile device with at least one functional module from an external control system, the functional module comprising coded instructions for executing a module process in the mobile device;
generating (16), in the external control system, an installation message comprising instructions for installing the at least one functional module into the mobile device;
communicating (18) the installation message to a local server located in the mobile device;
installing (20) the at least one functional module into the mobile device as a response to the installation message;
generating (22), in the external control system, an execution message comprising coded instructions for executing at least a part of the module process in the mobile device;
communicating (24) the execution message to the local server;
routing (26) the execution message by the local server to the at least one functional module; and
executing (28) the at least a part of the module process as a response to the execution message.

2. The method of claim 1, characterized by
checking (12) whether or not the at least one functional module exists in the mobile device; and
providing (14) the mobile device with the at least one functional module if the at least one functional module does not exist in the mobile device.

3. The method of claim 1, characterized by
communicating (426) local server software into the mobile device, the local server software comprising coded instructions for controlling installation and execution of a plurality of functional modules; and
installing (428) the local server software in order to obtain the local server.

4. The method of claim 1, characterized by
generating (442) a response message by the functional module as a response to the execution message;
routing (444), by the local server, the response message to the external control system;
receiving (446) the response message; and
processing (448) the response message.

5. The method of claim 1, characterized by
communicating (464) a remove message generated by the external control system to the local server; and
removing (466), by the local server, the at least one functional module as a response to the remove message.

6. The method of claim 1, characterized in that the at least one functional module comprises a common communication interface for communicating with the local server; and
the local server comprises a plurality of identical module interfaces compatible with the common communication interface.

7. The method of claim 1, characterized in that the mobile device comprises an operating system with a requirement of a user acknowledgement for installing the at least one functional module as a response to the installation message, the method further comprising overriding (436) the requirement of the user acknowledgement.

8. The method of claim 1, characterized in that the module process of the at least one functional module is a test process for testing at least one test object of the mobile device.

9. A mobile device of a wireless telecommunications system characterized in that the mobile device comprises:
a communication module (116) for communicating functional modules provided by an external control system (100) to the mobile device, a functional module comprising coded instructions for executing a module process in the mobile device; and
a local server (114) connected to the communication module (116), the local server (114) for installing at least one functional module (118A to 118C) communicated over the communication module (116) to the mobile device as a response to an installation message generated by the external control system (100) and communicated over the communication module (116), the local server (114) being configured to route an execution message generated by the external control system (100) to the at least one functional module (118A to 118C), the execution message comprising instructions for executing at least a part of the module process.

10. The mobile device of claim 9, characterized in that the local server (114) is configured to check whether or not the at least one functional module (118A to 118C) exists in the mobile device; and
the local server (114) is configured to inform the external control system (100) whether or not the at least one functional module (118A to 118C) exists in the mobile device.

11. The mobile device of claim 9, characterized in that the communication module (116) is configured to communicate local server software into the mobile device, the local server software comprising coded instructions for controlling installation and execution of a plurality of functional modules (118A to 118C; and
the local server (114) is further configured to install the local server software in order to obtain the local server.

12. The mobile device of claim 9, characterized in that the functional module (118A to 118C) is configured to generate a response message as a response to the execution message; and
the local server (114) is further configured to route the response message to the external control system (100).

13. The mobile device of claim 9, characterized in that the communication module (116) is configured to communicate a remove message generated by the external control system (100) to the local server (114); and
the local server (114) is configured to remove the at least one functional module (118A to 118C) as a response to the remove message.

14. The mobile device of claim 9, characterized in that the at least one functional module (118A to 118C) comprises a common communication interface (304) for communicating with the local server (114); and
the local server (114) comprises a plurality of identical module interfaces (306) compatible with the common communication interface (304).

15. The mobile device of claim 9, characterized in that the mobile device comprises an operating system with a requirement of a user acknowledgement for installing the at least one functional module (118A to 118C) as a response to the installation message; and
the local server (114) is configured to override the requirement of the user acknowledgement.

16. The mobile device of claim 9, characterized in that the module process of the at least one functional module (118A to 118C) is a test process for testing at least one test object of the mobile device.

17. A computer program embodied on a distribution medium readable by a computer and encoding a computer program of instructions for executing a computer process for operating a mobile device of a wireless telecommunications system, characterized in that the computer process comprises:
providing (14) the mobile device with at least one functional module from an external control system, the functional module comprising coded instructions for executing a module process in the mobile device;
generating (16), in the external control system, an installation message comprising instructions for installing the at least one functional module into the mobile device;
communicating (18) the installation message to a local server located in the mobile device;
installing (20) the at least one functional module into the mobile device as a response to the installation message;
generating (22), in the external control system, an execution message comprising coded instructions for executing at least a part of the module process in the mobile device;
communicating (24) the execution message to the local server;
routing (26) the execution message by the local server to the at least one functional module; and
executing (28) the at least a part of the module process as a response to the execution message.

18. A computer program embodied on a distribution medium readable by a computer and encoding a computer program of instructions for executing a computer process in a mobile device of a wireless telecommunications system, characterized in that the computer process comprises:
communicating (502) at least one functional module from an external control system to the mobile device, the functional module comprising coded instructions for executing a module process in the mobile device;
communicating (504) an installation message generated by the external control system;
installing (506) at least one functional module into the mobile device as a response to the installation message;
routing (508) an execution message generated by the external control system to the at least one functional module; and
executing (510) at least a part of the module process as a response to the execution message.

19. The computer program of claim 18, characterized in that the computer process further comprises:
checking (12) whether or not the at least one functional module exists in the mobile device; and
informing the external control system whether or not the at least one functional module exists in the mobile device.

20. The computer program of claim 18, characterized in that the computer process further comprises:
communicating (426) local server software into the mobile device, the local server software comprising coded instructions for controlling installation and execution of a plurality of functional modules; and
installing (428) the local server software in order to obtain the local server.

21. The computer program of claim 18, characterized in that the computer process further comprises:
generating (442) a response message by the functional module as a response to the execution message; and
routing (444), by the local server, the response message to the external control system.

22. The computer program of claim 18, characterized in that the computer process further comprises:
communicating (464) a remove message generated by the external control system to the local server; and
removing (466), by the local server, the at least one functional module as a response to the remove message.

23. The computer program of claim 18, characterized in that the at least one functional module comprises a common communication interface for communicating with the local server.

24. The computer program of claim 18, characterized in that the mobile device comprises an operating system with a requirement of a user acknowledgement for installing the at least one functional module as a response to the installation message; and
the computer process further comprises overriding (436) the requirement of the user acknowledgement.

25. The computer program of claim 18, characterized in that the module process of the at least one functional module is a test process for testing at least one test object of the mobile device.

26. A computer program embodied on a distribution medium readable by a computer and encoding a computer program of instructions for executing a computer process in an external control system, characterized in that the computer process comprises:
providing (14) the mobile device with at least one functional module, the functional module comprising coded instructions for executing a module process in;
generating (16) an installation message comprising instructions for installing the at least one functional module into the mobile device;
communicating (18) the installation message to the mobile device;
generating (22) an execution message comprising coded instructions for executing at least a part of the module process in the mobile device; and
communicating (24) the execution message to the mobile device.

27. The computer program of claim 26, characterized in that the computer process further comprises:
checking (12) whether or not the at least one functional module exists in the mobile device; and
providing (14) the mobile device with the at least one functional module if the at least one functional module does not exist in the mobile device.

28. The computer program of claim 26, characterized in that the computer process further comprises providing (424) the mobile device with local server software, the local server software comprising coded instructions for controlling installation and execution of a plurality of functional modules.

29. The computer program of claim 26, characterized in that the computer process further comprises:
receiving (446) a response message generated in the at least one functional module as a response to the execution message; and
processing (448) the response message.

30. The computer program of claim 26, characterized in that the computer process further comprises:
generating (462) a remove message comprising instructions for removing the at least one functional module from the mobile device; and
communicating (464) the remove message to the mobile device.

31. The computer program of claim 26, characterized in that the module process of the at least one functional module is a test process for testing at least one test object of the mobile device.
